(19) United States
(12) Patent Application Publication
(10) Pub. No.: US 2025/0187299 A1
(43) Pub. Date: Jun. 12, 2025

(54) Composite Jacket System for Improved Safety

(71) Applicant: West Virginia University Board of Governors on Behalf of West Virginia University, Morgantown, WV (US)

(72) Inventors: Hota GangaRao, Morgantown, WV (US); Ruifeng Liang, Morgantown, WV (US); Chao Zhang, Morgantown, WV (US)

(73) Assignee: West Virginia University Board of Governors on Behalf of West Virginia University, Morgantown, WV (US)

(21) Appl. No.: 18/974,148

(22) Filed: Dec. 9, 2024

Related U.S. Application Data
(60) Provisional application No. 63/607,535, filed on Dec. 7, 2023.

(51) Int. Cl. B32B 5/12; B32B 5/02; B32B 5/06; B32B 27/12; B32B 27/30; B32B 27/40; B65D 90/00

(52) U.S. Cl. CPC B32B 5/12; B32B 5/024; B32B 5/073; B32B 27/12; B32B 27/302; B32B 27/40; B61D 5/08; B32B 2250/05; B32B 2260/023; B32B 2260/046; B32B 2262/0269; B32B 2262/101; B32B 2307/3065; B32B 2307/7376; B32B 2439/40; B32B 2605/10

(57) ABSTRACT

In one aspect, the disclosure relates to a multifunctional fiber-reinforced polymer (FRP) composite jacket system configured to improve the safety of a container at least partially enclosed within the FRP composite jacket system. This can be accomplished by increasing the container's overall puncture resistance and thermal resistance which, in part, corresponds to a performance increase in terms of strength, energy absorption, and other efficiencies compared to traditional protective jacketing methods and materials. In a further aspect, this system can be applied to in-service tank cars as an in situ retrofit. Alternatively, it can be applied to newly manufactured tank cars as a design improvement over traditional approaches to existing outer jackets of tank cars. This abstract is intended as a scanning tool for purposes of searching in the art and is not intended to be limiting of the present disclosure.

### CROSS REFERENCE TO RELATED APPLICATIONS

This application claims priority to, and the benefit of, U.S. provisional application entitled “Composite Jacket to Retrofit In-service Tank Cars for Improved Safety” having Ser. No. 63/607,535, filed Dec. 7, 2024, which is hereby incorporated by reference in its entirety.

### STATEMENT REGARDING FEDERALLY SPONSORED RESEARCH OR DEVELOPMENT

This invention was made with government support under 693JK3-20-C-000008 awarded by the U.S. Department of Transportation. The government has certain rights in the invention.

### FIELD

This disclosure generally relates to fiber-reinforced polymer (FRP) composite structures. More specifically, the disclosed embodiments relate to FRP composite jacket systems and methods of manufacture for improving the safety of containers that contain hazardous materials (HMs).

### BACKGROUND

The United States Department of Transportation (USDOT) has a goal to improve the performance of hazardous materials (HMs) packaging in transportation. In North America, railroad tank cars are the main transportation mode for carrying flammable fluids and other HMs, especially over longer distances. These tank cars carry chemicals, petroleum products, and other HMs that when meeting with an accident or derailment, can release significant amounts of HMs into the environment posing serious threat to human hazards and economic losses. To minimize catastrophes, recent government regulations require both new and existing tank cars to meet new design criteria to reduce the probability and consequence of accidents that occur involving tank cars carrying large volumes of HMs (e.g. DOT-117, DOT-117R, DOT CPC-1232, etc.). Conventional methods to increase tank car safety by adding high quality steel and increasing its thickness can be a solution to improve the impact and puncture resistance of tank cars. However, the added steel weight significantly reduces the carrying capacity of a tank car resulting in reduced shipping capacity and increase shipping costs. The cost to conventionally retrofit and replace tank car fleets also produces lost revenue while the tank cars are out of service for prolonged periods of time.

### SUMMARY

In accordance with the purpose(s) of the disclosure, as embodied and broadly described herein, the disclosure, in one aspect, relates to fiber-reinforced polymer (FRP) composite jacket systems configured to improve the safety of containers partially or fully enveloped by the composite jacket system by providing superior puncture and thermal behavior at higher specific strength and specific energy absorption compared to conventional methods. In one embodiment, the FRP composite jacket system can comprise the outer surface of the container, a core layer comprising a polymeric material, an outer jacket comprising a plurality of plies comprised of aramid fabric layers and glass fabric layers joined together by a plurality of stitch lines, wherein at least one ply is oriented in an on-axis direction and at least one ply is oriented in an off-axis direction. Further, the core layer and the outer jacket are compressed against the outer surface of the container and bonded by a thermosetting resin to form the FRP composite jacket system.

In a further aspect, the FRP composite jacket system can be applied to the outer surface of a tank car shell using vacuum-assisted resin transfer molding (VARTM). The tank car can be an in-service tank car wherein the FRP composite jacket system is an in situ retrofit. In an alternate embodiment, the FRP composite jacket system can be manufactured as a component of a new tank car wherein the tank car shell is an inner tank shell of the tank car. In an additional aspect, the FRP composite jacket system can be an assembly of components prior to resin infusion.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the independent claims, as well as all optional and preferred features and modifications of the described embodiments are combined and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a longitudinal and transverse view of an exemplary container covered with a FRP composite jacket system.

FIG. 2 is an isometric view of components that can comprise an exemplary FRP composite jacket system.

FIG. 3 illustrates an exemplary sequence of layers that can comprise an FRP composite jacket system.

FIG. 4 illustrates an exemplary application of an FRP composite jacket system installed as a retrofit on an in-service tank car.

FIG. 5 illustrates an exemplary application of an FRP composite jacket system installed on a new tank car.

FIG. 6 illustrates an alternative application of an FRP composite jacket system installed on a new tank car.

FIG. 7 shows a photograph of FRP composite test specimens being manufactured via VARTM.

FIG. 8 shows specific energy absorption data comparing the performance of various types of Kevlar® fabric layers to each other.

FIG. 9 shows load as a function of deflection data comparing the performance of unstitched outer jacket layers versus stitched outer jacket layers to each other.

FIG. 10 shows specific energy absorption data comparing the performance of various layer quantities comprising an outer jacket to each other.

FIG. 11 shows load as a function of deflection data comparing the performance of 12 and 18 total outer jacket layers to each other.

FIG. 12 shows load as a function of deflection data comparing the performance of 18, 24, and 30 outer jacket layers to each other.

FIG. 13 illustrates the energy absorption performance between conventional DOT 117 conditions and an exemplary FRP composite jacket system.

### DETAILED DESCRIPTION

Disclosed herein are various examples related to FRP composite jackets to improve the impact and puncture resistance of a container, for example, tank cars subjected to a derailment. Reference will now be made in detail to the description of the embodiments as illustrated in the drawings, wherein like reference numbers indicate like parts throughout the several views.

In some embodiments, the FRP composite jacket system may comprise a cover, a wrap, shell, or sleeve typically configured to be provided on or around at least a portion of an outer surface of a container. The composite jacket system may be used as a standalone shell, covering, or customizable system or may be included within another system. In some embodiments, the FRP composite jacket system may refer to a subassembly provided as a secondary shell covering, for example, serving as an outer shell to an inner tank shell or primary tank shell containing a HM. As a secondary shell, the composite jacket system may provide additional protective shielding to guard against puncture during a collision or to protect the underside of the primary tank shell from damage. Further, the composite jacket system may provide fire-resistance in the form of fire-resistant materials integrated within the FRP composite jacket system or through additional outer surface coatings or layers. These coatings may be designed to delay heat penetration during fire exposure, such as an intumescent coating or paint that may expand and form a char layer when exposed to heat, insulating the underlying container. The composite jacket system may also be configured to provide additional environmental protection from exposure to acidic or alkaline environments, corrosion, deformation, wear and fatigue, or other damage. The composite jacket system may also provide thermal insulation to help regulate the thermal environment of a container with respect to the surrounding environment.

In some embodiments, the composite jacket system is adaptable and configurable for a variety of containers of different shapes, sizes, dimensions, operating conditions, and insulation requirements. Typically, the composite jacket system is self-molding by conforming to the shape or contour of the container onto which it is applied prior to curing. Furthermore, the composite jacket structural attributes such as its overall thickness and material property characteristics like thermal conductivity can be variable, for example, by varying the properties of its features such as the core layer, the plies comprising the outer jacket, or variations with the resin composition or the infusion process.

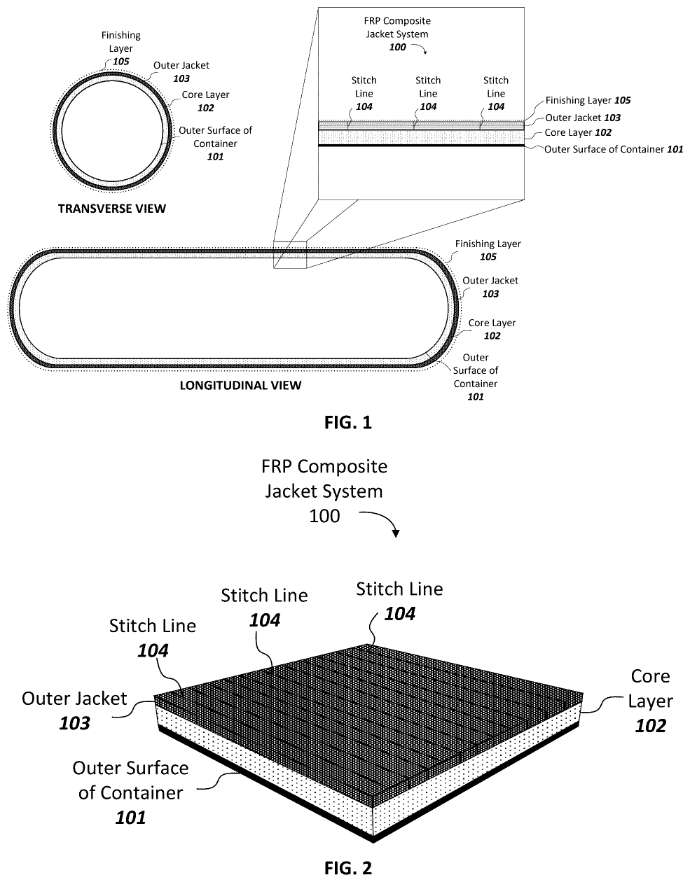

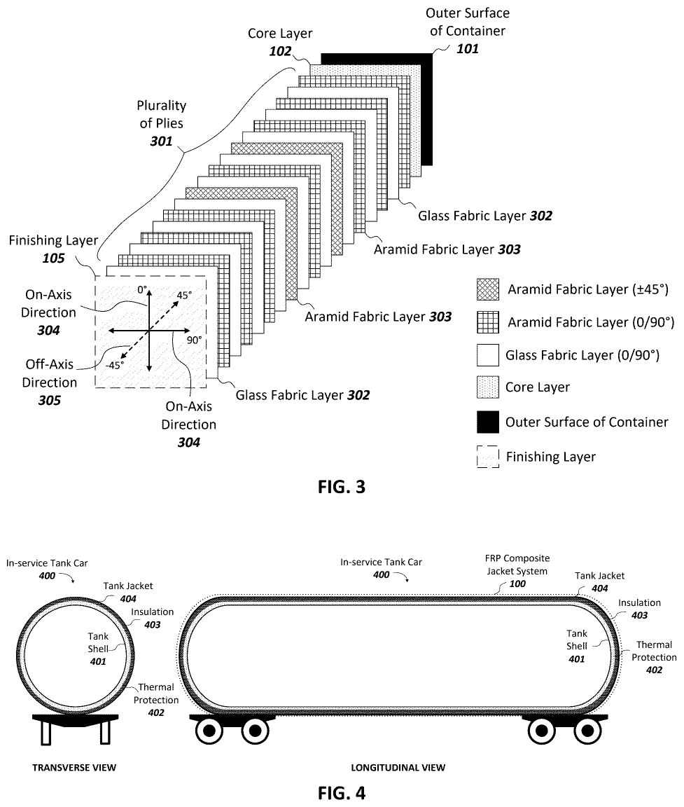

The composite jacket system and its embodiments will now be described in detail with respect to FIG. 1-3. FIG. 1-3 illustrate one embodiment, wherein a fiber-reinforced polymer (FRP) composite jacket system 100 comprises an outer surface of a container 101, a core layer 102, and an outer jacket 103 comprising a plurality of plies 301 joined together by a plurality of stitch lines 104. FIG. 3 illustrates how layers comprising the composite jacket system 100 can be configured with respect to one another. The plurality of plies 301 can comprise at least one glass fabric layer 302 in contact with at least one aramid fabric layer 303. At least one of the plies of the plurality of plies 301 comprise fibers substantially oriented in an on-axis direction 304 and at least one of the plies of the plurality of plies 301 comprise fibers substantially oriented in an off-axis direction 305. An on-axis direction 304 is a direction defined by a reference axis. Conversely, an off-axis direction 305 is a direction defined at an off-set angle with respect to a reference axes. In FIG. 3, 0° and 90° are reference axes that are orthogonal to each another and respectively define an on-axis direction 304. The +45° direction is an example off-axis direction 305. At least a portion of the outer surface of the container 101 can be in contact with an inner surface of the core layer 102. An outer surface of the core layer 102 can be in contact with an inner surface of the outer jacket 103. The core layer 102 and the outer jacket 103 can be compressed against at least a portion of the outer surface of the container 101 and bonded by a thermosetting epoxy resin to form the FRP composite jacket system 100.

The outer surface of a container 101 can have a curvilinear shape. As nonlimiting examples, the outer shape can be substantially spherical, elliptical, cylindrical, or tubular where stress points can be reduced compared to predominantly rectilinear shapes. As used herein, “container” can refer to a structure resistant to deformation and designed to hold, store, or transport physical materials in various material phases within ambient or relatively lower or higher temperature and pressure conditions. As nonlimiting examples, an outer surface of a container 101 can comprise a metal or metal alloy such as a steel, a plastic or other polymer, a ceramic, a wood, or other fiber-reinforced multi-material composite capable of bonding with a thermosetting epoxy resin.

The core layer 102 can be a polymeric material. As used herein, a polymeric material can be a low-density material comprised of natural or synthetic polymers such as, but not limited to, lightweight plastics, rubbers, and foams with a porous structure capable of exhibiting flexibility or rigidity. Nonlimiting examples of polymeric materials comprising the core layer 102 can be polyurethane or polystyrene-based foams or elastomeric pads materials. To increase both fire and impact resistance, a syntactic foam can be used further comprising additive particles or micro fillers such as but not limited glass, ceramic, carbon, or polymers. Additional material examples include silicon dioxide, ammonium polyphosphate, cut-glass fiber, or coal ash. The core layer 102 can be about 0.55-in thick. The core layer can comprise extruded polystyrene. The core layer 102 can act as a sacrificial layer by increasing the energy absorption capacity of the FRP composite jacket system 100 by undergoing densification during impact and relatively larger bending before failure.

The plurality of plies 301 comprising the outer jacket 103 can comprise an aramid fabric layer 303 and a glass fabric layer 302 in alternating sequential contact. Further, the inner surface of the outer jacket 103 can comprise an aramid fabric layer 303 to optimize the puncture resistance of the FRP composite jacket system 100. The outer surface of the outer jacket 103 can comprise a glass fabric layer 302 to provide a suitable substrate for the finishing layer 105 such that a multitude of multifunctional material coatings can be easily adhered. As nonlimiting examples, a glass fabric layer 302 can comprise an E-glass, an S-glass, an A-glass, a Z-glass, a K-glass, a C-glass, or an R-glass. A glass fabric layer 302 can have a bidirectional weave. A glass fabric layer 302 can have an areal density of about 0.231 g/in². E-glass fibers are highly compatible with polyester and epoxy resins due to their low moisture and favorable mechanical properties.

An aramid fabric layer 303 or an aromatic polyamide fabric layer can comprise aramid fibers also known as Kevlar®, a trade name of Dupont™. Nonlimiting examples of aramid fibers can include Kevlar® KM2®, Kevlar® KM2® Plus, or Kevlar® 49. An aramid fabric layer 303 can comprise a plain or basic weave pattern, wherein the warp and weft yarns intersect one over the other alternating and forming a simple, balanced structure. An aramid fabric layer 303 can also comprise a twill pattern. In various nonlimiting examples, an aramid fabric layer 303 can have an areal density of about 0.116 g/in². An aramid fabric layer 303 can also comprise 400, 600, or 3000 denier yarn. An aramid fabric layer 303 can also comprise about 17, 23, or 34 yarns per inch in the lengthwise or longitudinal (warp) and horizontal (weft) directions.

In an alternate embodiment, the plurality of plies 301 comprising the outer jacket 103 can comprise at least six (6) aramid fabric layers 303 in alternating sequential contact with at least six (6) glass fabric layers 302.

In an embodiment illustrated by Example A in Table 1, the plurality of plies 301 comprising the outer jacket 103 can comprise nine (9) aramid fabric layers 303 in alternating sequential contact with nine (9) glass fabric layers 302 comprising a plurality of plies 301 of eighteen (18) in total. Further, fibers of aramid fabric layer four of nine (4 of 9) and fibers of aramid fabric layer six of nine (6 of 9) can be substantially oriented about plus/minus forty-five degrees (±45°) in an off-axis direction 305. The rest of the layers comprising an exemplary FRP composite jacket system 100 are further provided in Example A for completeness. The layer configuration described in Example A is also illustrated in FIG. 3.

In an embodiment as illustrated by Example B in Table 1, the plurality of plies 301 comprising the outer jacket 103 can comprise nine (9) aramid fabric layers 303 in alternating sequential contact with nine (9) glass fabric layers 302 comprising a plurality of plies 301 of eighteen (18) in total. Further, fibers of glass fabric layer 302 three of nine (3 of 9) and fibers of aramid fabric layer six of nine (6 of 9) can be substantially oriented about plus/minus forty-five degrees (±45°) in an off-axis direction 305. The rest of the layers comprising an exemplary FRP composite jacket system 100 are further provided in Example A for completeness.

In an embodiment as illustrated by Example C in Table 1, the plurality of plies 301 comprising the outer jacket 103 can comprise nine (9) aramid fabric layers 303 in alternating sequential contact with nine (9) glass fabric layers 302 comprising a plurality of plies 301 of eighteen (18) in total. Further, fibers of aramid fabric layer 303 four of nine (4 of 9) can be substantially oriented about thirty degrees (30°) in an off-axis direction 305. Further, fibers of glass fabric layer 302 four of nine (4 of 9) can be substantially oriented about sixty degrees (60°) in an off-axis direction 305. The rest of the layers comprising an exemplary FRP composite jacket system 100 are further provided in Example A for completeness.

TABLE 1
Exemplary FRP Composite Jacket System Layer Configurations.

| | | Example A Fiber | Example B Fiber | Example C Fiber | Approximate |
|---|---|---|---|---|---|
| | | Orientation | Orientation | Orientation | Layer Thickness |
| Layer No. | Layer Description | (°) | (°) | (*) | (in) |
| (N/A) | Outside Surface | N/A | N/A | N/A | N/A |
| | of Steel Container | | | | |
| 1 | Core Layer | N/A | N/A | N/A | 0.55 |
| 2 | Aramid Fabric | 0 | 0 | 0 | 0.01 |
| 3 | Glass Fabric | 0 | 0 | 0 | 0.01 |
| 4 | Aramid Fabric | 0 | 0 | 0 | 0.01 |
| 5 | Glass Fabric | 0 | 0 | 0 | 0.01 |
| 6 | Aramid Fabric | 0 | 0 | 0 | 0.01 |
| 7 | Glass Fabric | 0 | −45 | 0 | 0.01 |
| 8 | Aramid Fabric | −45 | 0 | 30 | 0.01 |
| 9 | Glass Fabric | 0 | 0 | 60 | 0.01 |
| 10 | Aramid Fabric | 0 | 0 | 0 | 0.01 |
| 11 | Glass Fabric | 0 | 0 | 0 | 0.01 |
| 12 | Aramid Fabric | −45 | −45 | 0 | 0.01 |
| 13 | Glass Fabric | 0 | 0 | 0 | 0.01 |
| 14 | Aramid Fabric | 0 | 0 | 0 | 0.01 |
| 15 | Glass Fabric | 0 | 0 | 0 | 0.01 |
| 16 | Aramid Fabric | 0 | 0 | 0 | 0.01 |
| 17 | Glass Fabric | 0 | 0 | 0 | 0.01 |
| 18 | Aramid Fabric | 0 | 0 | 0 | 0.01 |
| 19 | Glass Fabric | 0 | 0 | 0 | 0.01 |
| 20 | Finishing layer | N/A | N/A | N/A | 0.01 |

The plurality of stitch lines 104 can be substantially parallel. The plurality of stitch lines 104 can also be spaced about 0.25-in to 1-in apart. The direction of the plurality of stitch lines can also be in an on-axis direction 304. The plurality of stitch lines 104 can also comprise a mechanical stitch utilizing an aramid thread. The plurality of stitch lines 104 can also comprise thread weight ranging from about two (2) to eight (8) denier. Further, a stitch line comprising the plurality of stitch lines 104 can comprise an upper thread and a lower thread such that the upper thread and the lower thread form, as a nonlimiting example, a lockstitch pattern. The upper thread can have a higher thread weight in comparison to the lower thread. The upper thread can substantially face the outer surface of the outer jacket 103 and be exposed to greater environmental or mechanical stresses, whereas the lower thread can substantially face the inner surface of the outer jacket 103 and be exposed to relatively less environmental or mechanical stresses compared to the upper thread.

In other embodiments, the FRP composite jacket system 100 can further comprise a finishing layer 105 in contact with an outer surface of the outer jacket 103. The finishing layer 105 can comprise intumescent material additives, fire-retardant materials to prevent heat, oxygen, and other combustible gases from entering or leaving the FRP composite jacket system 100, or other materials to meet an alternative protective need of the container from perhaps harsh weather or other environmental exposure. A nonlimiting example of an intumescent additive can be an acrylic latex, single component coating with a trade name Contego Original Formula Reactive Fire Barrier Intumescent (RFB). The core layer 102 or the outer jacket 103 can also contain intumescent material additives or other fire-retardant materials. Fire-retardant materials or other insulative or barrier-forming materials can have material properties consistent with effectively reducing flammability, slowing down the spread of fire, or suppressing flames, characterized by relatively high decomposition or high ignition temperatures, low thermal conductivity, high heat capacity, and/or possess an endothermic reaction capability. The finishing layer 105 can also modify the external surface roughness of the outer jacket 103 to optimize the aerodynamics over the container, in a nonlimiting example such as to decrease the drag force imparted on a tank car while in transit.

The core layer 102 and the outer jacket 103 can be compressed against at least a portion of the outer surface of the container 101 using a vacuum-assisted resin transfer molding (VARTM) method. Aspects of VARTM can be optimized to minimize the void content within the final FRP composite jacket system 100. As a nonlimiting example, the resin bleed time can be set between about six (6) to fourteen (14) minutes to extend the duration of the vacuum process and ensure excess resin is removed, thereby increasing the fiber volume fraction of the FRP composite jacket system 100. Further, a spiral tube spacing of about 0.27±0.2 in was employed to deploy the flow media and achieve a uniform resin distribution during the infusion process. This uniform distribution helps achieve saturation in distant corners of the composite. In addition, a resin infusion temperature of about 45±5° C. can be enforced to balance the resin flow rate and viscosity to enhance structural integrity and global bonding of the composite. Preheating certain elements of the FRP composite jacket system 100 can also improve resin filtration efficiency.

A thermosetting epoxy resin can be used to perform VARTM wherein the thermosetting epoxy resin generates a bond between the outer surface of the container 101 and the core layer 102, a bond between the core layer 102 and the outer jacket 103, as well as a bond between each ply within the plurality of plies 301 comprising the outer jacket 103 to form the FRP composite jacket system 100. In a nonlimiting example, the thermosetting epoxy resin can comprise Sikadur® Hex-300. The thermosetting epoxy resin can also comprise epichlorohydrin, polyoxypropylenediamine, or combinations thereof.

In an additional embodiment, the FRP composite jacket system 100 can be applied to retrofit a pre-existing conventional in-service tank car 400 in situ using the features of the FRP composite jacket system 100 via VARTM. FIG. 4 illustrates the typical components of an in-service tank car 400, which can include a tank shell 401, thermal protection 402, insulation 403, and a tank jacket 404. In this nonlimiting example, the tank jacket 404 can be the outer surface of the container 101, which can comprise the innermost layer of the FRP composite jacket system 100. The tank jacket 404 is also known as an outer tank car shell.

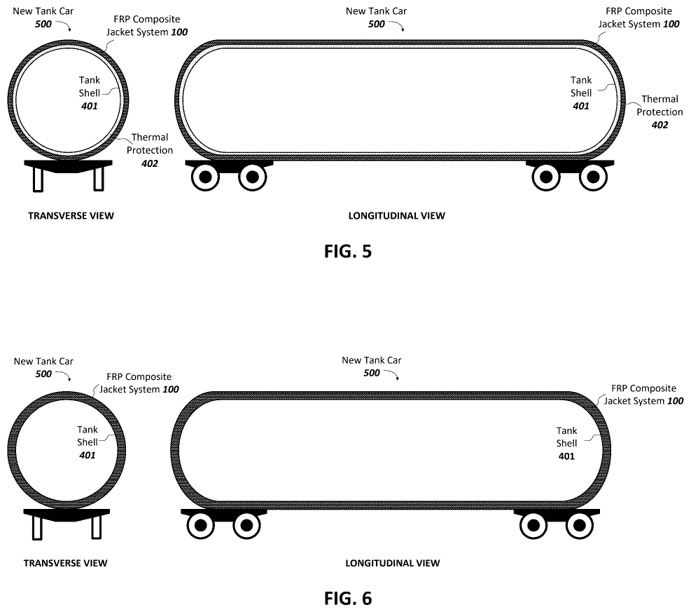

In another embodiment, the FRP composite jacket system 100 can be applied as a component of a new tank car 500 wherein the FRP composite jacket system 100 can be installed using VARTM to collectively replace the insulation 403 and tank jacket 404 typically installed on a conventional in-service tank car 400 (See FIG. 5). In this nonlimiting example, thermal protection 402 can be the outer surface of the container 101, which can comprise the innermost layer of the FRP composite jacket system 100.

In an alternate embodiment, the FRP composite jacket system 100 can be applied as a component of a new tank car 500 wherein the FRP composite jacket system 100 can be installed using VARTM to collectively replace the insulation 403, the tank jacket 404, as well as thermal protection 402 typically installed on a conventional in-service tank car 400 (See FIG. 6). In this nonlimiting example, the tank shell 401 can be the outer surface of the container 101, which can comprise the innermost layer of the FRP composite jacket system 100. The tank shell 401 is also known as an inner tank car shell.

In an alternate embodiment, the FRP composite jacket can be an assembly or perform of dry layers pre-configured prior to resin infusion. A plurality of aramid fabric layers 303 and a plurality of glass fabric layers 302 comprising the outer jacket 103 can also be pre-stitched together in a similar manner as previously presented. The FRP composite jacket assembly can comprise a core layer 102, an outer jacket 103 further comprising a plurality of plies joined together by a plurality of stitch lines 104. The stitch lines 104 can comprise aramid thread with thickness in the range of two (2) to eight (8) denier. The stitch lines can be substantially parallel and spaced about 0.25 to 1.0 inches apart. The plurality of plies 301 can comprise at least six (6) aramid fabric layers 303 in sequential alternating contact with at least six glass fabric layers 302. At least one of the plies of the plurality of plies 301 can comprise fibers substantially oriented in an on-axis direction 304, and at least one of the plies of the plurality of plies 301 can comprise fibers substantially oriented in an off-axis direction 305 ranging between about thirty (30) and sixty (60) degrees. An outer surface of the core layer 102 can be in contact an inner surface of the outer jacket 103. The inner surface of the outer jacket 103 can also comprise aramid fabric layer 303 and the outer surface of the outer jacket 103 can comprise a glass fabric layer 302.

### EXPERIMENTAL PERFORMANCE RESULTS

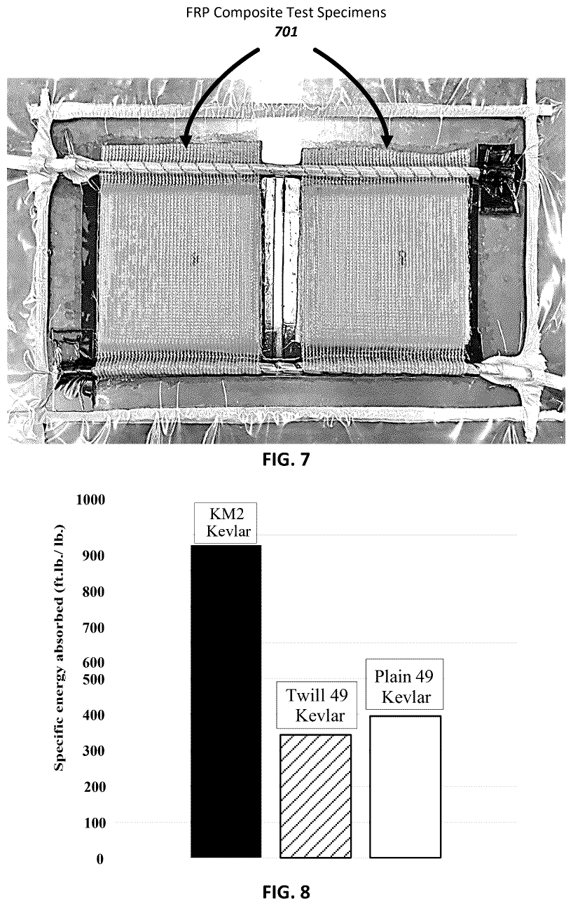

A large-scale experimental study was performed applying VARTM methods to manufacture 7×7-in FRP composite test specimens with high fiber volume fraction. FIG. 7 shows a photograph of two exemplary FRP composite test specimens 701 being produced. Static puncture and dynamic impact tests were conducted on the FRP composite test specimens 701 to determine both the puncture and impact behaviors of steels and composites. Static puncture tests were conducted on an Instron 8501 based on ASTM D6264 procedures and dynamic impact tests were conducted on a CEAST 9350 Instron drop weight impact tower based on ASTM D7136 procedures. A flat or curvilinear steel plate was used as needed as a substrate to simulate an external surface of a container, such as a tank car.

Different parameters associated with the puncture and impact behavior of FRP composite jackets were evaluated. The parameters under consideration were fabric layer combinations and stacking sequences, thru-thickness stitching of fabric layers, resin types, core materials, and altering the number of reinforcement fabric layers or plies within an FRP composite jacket. These parameters were then optimized via further testing and analysis to derive the most efficient composite jacket in terms of strain energy to failure. The best performing composite coupons were then tested in the presence of a core foam layer and steel substrate under static puncture and dynamic impact loads to determine their puncture and impact behaviors in an applicable tank car scenario.

Hybrid composites comprised of glass and aramid (Kevlar® KM-2®) fabric layers exhibited superior impact and puncture behavior compared to composites manufactured with glass fabrics only. However, mild performance drawbacks in addition to increased expense limited the possibility of utilizing aramid fabric layers 303 only for reinforcement. The addition of glass fabric layers 302 maintains the FRP composite jacket system as a cost-effective solution while increasing the ease of resin infusion. Among the Kevlar® fabrics tested, Kevlar® KM-2® had high toughness because of its densely woven threads and was more difficult to penetrate compared to 49 Kevlar® plain and twill weave fabric layers. Thus, Kevlar® KM-2® composites had superior relative impact and puncture performance (See FIG. 8). Similarly, epoxy provided better adhesion between glass and Kevlar®-based fabrics which aided stress transfer, resulting in epoxy-based composites exhibiting better ductility and puncture resistance compared to vinyl ester composites. Epoxy-based solutions also slightly increased the interlaminar shear strength of the FRP composite jacket.

Through-thickness stitching of glass and aramid fabric layers 303 at a spacing of 0.5 in optimized the through-thickness properties of the FRP composite without a reduction to in-plane material properties. Additional compaction of the fabric layers through stitching reduced the modulus of elasticity of FRP composite jacket samples in tension. The heavier weight (i.e. 4- and 6-denier) Kevlar® stitching threads caused more breakage and misalignment on in-plane fibers which resulted in the reduction of in-plane materials properties compared to stitching with lower weight (i.e. 2- and 4-denier) threads. Stitching aided interlaminar shear strength, which allowed for cohesion between the layers even after sample failure and reduced the modulus and bending strength due to stress concentrations created by stitching. FIG. 9 illustrates the performance increase stitching glass and aramid fabric layers 303 together versus leaving them unstitched.

The use of an FRP composite jacket system over a steel substrate improved the puncture resistance of steel by about 1.5 times. The total static puncture energy absorption of steel increased by about 2.1 times when an approximate 0.55-in extruded foam core layer was added to an outer composite jacket comprised of glass and Kevlar® fabric layers.

The use of fabric layers with ±45 fiber orientations helped improve the shear performance of the FRP composite jacket system as the weak link of shear failure was partly mitigated by the presence of fibers in those directions. The increase in thickness of the composites increased the stiffness of the composites but reduced ductility and strength as shear and bending failure stresses were reached at much lower deflection reducing the energy absorption before failure. The curvature in steel and composites helped to increase the puncture energy absorption under fixed boundary conditions.

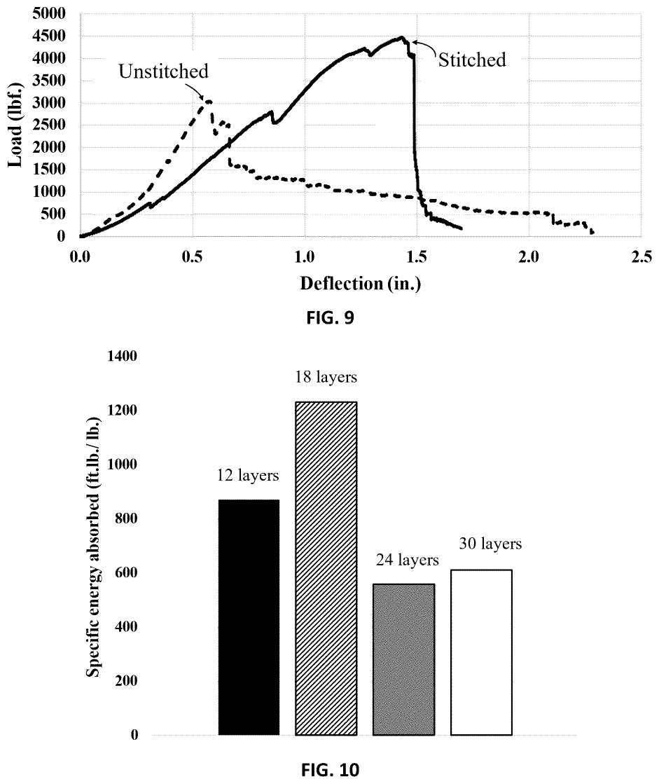

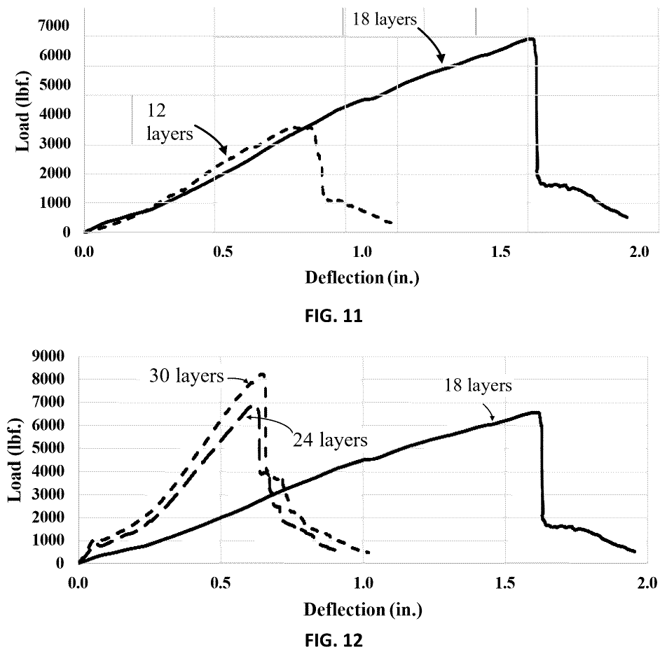

The use of eighteen (18) layers of nine (9) aramid fiber layers in alternating sequential contact with nine (9) glass fiber lays exhibited optimal material strength properties and maximized puncture resistance compared to similar layer configurations of 12 (twelve), twenty-four (24), and thirty (30) total layers (see FIGS. 10-12).

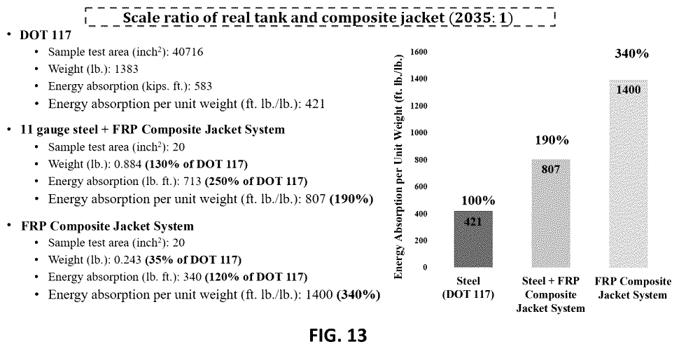

The collective test results for a FRP composite jacket system over a steel substrate (or outer surface of a steel container) were compared with DOT-117 tank cars test results confirmed the superior puncture and impact performances of the FRP composite jacket system. FIG. 13 illustrates energy absorption performance characteristics between DOT 117 guidelines compared to the performance increase imparted by a FRP composite jacket system.

The FRP composite jacket system can be about 4.3 times lighter by weight than the DOT 117 outer steel shell and performs about 1.9 times better in terms of specific energy absorption under dynamic impact loading. Moreover, the FRP composite jacket system is about 2.1 times better than the DOT 117 outer steel shell in terms of specific energy adsorption under dynamic loading. Testing the combination of the total FRP composite jacket system with a steel substrate at steel failure would exhibit greater results.

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of”.

As used in the specification and the appended claims, the singular forms “a,” “an” and “the” include plural referents unless the context clearly dictates otherwise. Thus, for example, reference to “a metal,” “a metal oxide,” or “an oxidizing agent,” including, but not limited to, mixtures or combinations of two or more such metals, metal oxides, or oxidizing agents, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Unless otherwise specified, temperatures referred to herein are based on atmospheric pressure (i.e. one atmosphere).

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

### REFERENCES

ASTM Committee D30 on Composite Materials. Standard Test Method for Measuring the Damage Resistance of a Fiber-reinforced Polymer Matrix Composite to a Drop-weight Impact Event: D7136/D7136M-15. ASTM International, 2015.
ASTM D6264-98, Test Method for Measuring the Damage Resistance of a Fiber-reinforced Polymer-matrix Composite to a Concentrated Quasi-static Indentation Force, Book of Standards 2004.
ASTM D7264/D7264M. (2021). Standard Test Flexural Properties of Polymer Matrix Composite Materials. ASTM International.
Abou El-Mal H S S, Sherbini A S, Sallam H E M. Mode Il Fracture Toughness of Hybrid FRCs. International Journal of Concrete Structures and Materials. 2015; 9:475-86.
Atadero, Rebecca, Luke Lee, and Vistasp M. Karbhari. “Consideration of material variability in reliability analysis of FRP strengthened bridge decks.” Composite Structures 70.4 (2005): 430-443.
Atas C and Liu D. Impact response of woven composites with small weaving angles. Int J Impact Eng 2008; 35:80-97.
Banthia N, Gupta R. Hybrid fiber reinforced concrete (HyFRC): fiber synergy in high strength matrices. Materials and Structures. 2004; 37:707-16.
Chinnasamy, Vivekanandhan, et al. “Characterization on thermal properties of glass fiber and Kevlar® fiber with modified epoxy hybrid composites.” Journal of materials research and technology 9.3 (2020): 3158-3167.
Crema, L. Balis, A. Castellani, and U. Drago. “Damping characteristics of fabric and laminated Kevlar® composites.” Composites 20.6 (1989): 593-596.
Dittenber, David and GangaRao, Hota V. S., “Natural Fiber Reinforced Composites for Civil Infrastructure—Overview and Experimental Work” (2013). Engineering and Computer Science Faculty Publications. 430.
Fan, Ting, et al. “Novel Kevlar® fabric composite for multifunctional soft body armor.” Composites Part B: Engineering 242 (2022): 110106.
Humphreys, Matthew, and Kym Francey. “An investigation into the rehabilitation of timber structures with fibre composite materials.” Developments in Mechanics of Structures and Materials (2005): 1317-1322.
Kang, Tae Jin, and Cheol Kim. “Energy-absorption mechanisms in Kevlar® multiaxial warp-knit fabric composites under impact loading.” Composites Science and Technology 60.5 (2000): 773-784.
Lee, Hee Young, Woo Tai Jung, and Wonseok Chung. “Flexural strengthening of reinforced concrete beams with pre-stressed near surface mounted CFRP systems.” Composite Structures 163 (2017): 1-12.
Liang, R., and G. Hota. “Fiber-reinforced polymer (FRP) composites in environmental engineering applications.” Developments in fiber-reinforced polymer (FRP) composites for civil engineering. Woodhead Publishing, 2013. 410-468.
Meyer, P. I. “Low-velocity hard-object impact of filament-wound Kevlar®/epoxy composite.” Composites Science and Technology 33.4 (1988): 279-293.
Rubino, Felice, et al. “Marine application of fiber reinforced composites: a review.” Journal of Marine Science and Engineering 8.1 (2020): 26.
Saba, N., and M. Jawaid. “A review on thermomechanical properties of polymers and fibers reinforced polymer composites.” Journal of industrial and engineering chemistry 67 (2018): 1-11.
Triantafillou, Thanasis C. “Composites: a new possibility for the shear strengthening of concrete, masonry and wood.” Composites science and technology 58.8 (1998): 1285-1295.
Vijay, P. V., et al. “Repair and strengthening of submerged steel piles using GFRP composites.” Journal of Bridge Engineering 21.7 (2016): 04016038.
Wang, Youjiang, Jian Li, and Dongming Zhao. “Mechanical properties of fiber glass and Kevlar® woven fabric reinforced composites.” Composites Engineering 5.9 (1995): 1159-1175
Wei, Minghai, Li Sun, and Jie Zhu. “Effects of parameters controlling the impact resistance behavior of the GFRP fabric impregnated with a shear thickening fluid.” Materials & Design 196 (2020): 109078.
Xiao, Y. “Applications of FRP composites in concrete columns.” Advances in Structural Engineering 7.4 (2004): 335-343.
Yadav, S. N., Vijai Kumar, and Sushil K. Verma. “Fracture toughness behaviour of carbon fibre epoxy composite with Kevlar® reinforced interleave.” Materials Science and Engineering: B 132.1-2 (2006): 108-112.
Yang B, Kozey V, Adanur S, et al. Bending, compression, and shear behavior of woven glass fiber-epoxy composites. Compos Part B 2000; 31:715-721.
Yuanjian, Tong, and D. H. Isaac. “Combined impact and fatigue of glass fiber reinforced composites.” Composites Part B: Engineering 39.3 (2008): 505-512.

At least the following is claimed:

1. A fiber-reinforced polymer (FRP) composite jacket system, comprising:
at least a portion of an outer surface of a container;
a core layer comprising a polymeric material;
an outer jacket comprising a plurality of plies joined together by a plurality of stitch lines;
wherein the plurality of plies comprises at least one aramid fabric layer in contact with at least one glass fabric layer;
wherein at least one of the plies of the plurality of plies comprises fibers substantially oriented in an on-axis direction;
wherein at least one of the plies of the plurality of plies comprises fibers substantially oriented in an off-axis direction;
wherein at least a portion of the outer surface of the container is in contact with an inner surface of the core layer;
wherein an outer surface of the core layer is in contact with an inner surface of the outer jacket; and
wherein the core layer and the outer jacket are compressed against at least a portion of the outer surface of the container and bonded by a thermosetting epoxy resin to form the FRP composite jacket system.

2. The composite jacket system of claim 1, wherein the container outer surface of the container is curvilinear.

3. The composite jacket system of claim 1, wherein the polymeric material comprises a polystyrene material, a polyurethane material, an elastomeric material, or combinations thereof.

4. The FRP composite jacket of claim 1, wherein the plurality of stitch lines is substantially parallel.

5. The FRP composite jacket of claim 1, wherein the plurality of stitch lines is spaced about 0.25 to 1.0 inches apart.

6. The FRP composite jacket of claim 1, wherein the plurality of stitch lines comprises aramid thread ranging between about two (2) to eight (8) denier.

7. The FRP composite jacket system of claim 1, wherein the plurality of plies comprises at least six (6) aramid fabric layers in alternating sequential contact with at least six (6) glass fabric layers.

8. The FRP composite jacket system of claim 1, further comprising a finishing layer in contact with an outer surface of the outer jacket.

9. The FRP composite jacket system of claim 1, further comprising an intumescent material in contact with an outer surface of the outer jacket.

10. The FRP composite jacket system of claim 1, wherein the inner surface of the outer jacket comprises an aramid fabric layer and an outer surface of the outer jacket comprises a glass fabric layer.

11. The FRP composite jacket system of claim 1,
wherein the plurality of plies comprises nine (9) aramid fabric layers in alternating sequential contact with nine (9) glass fabric layers; and
wherein fibers of aramid fabric layer four (4) of nine (9) and fibers of aramid fabric layer six (6) of nine (9) are substantially oriented about forty-five (45) degrees in an off-axis direction.

12. The FRP composite jacket system of claim 1,
wherein the plurality of plies comprises nine (9) aramid fabric layers in alternating sequential contact with nine (9) glass fabric layers; and
wherein fibers of glass fabric layer three (3) of nine (9) and fibers of aramid fabric layer six (6) of nine (9) are substantially oriented about forty-five (45) degrees in an off-axis direction.

13. The FRP composite jacket system of claim 1,
wherein the plurality of plies comprises nine (9) aramid fabric layers in alternating sequential contact with nine (9) glass fabric layers;
wherein fibers of aramid fabric layer four (4) of nine (9) are substantially oriented about thirty (30) degrees in an off-axis direction; and
wherein fibers of glass fabric layer four (4) of nine (9) are substantially oriented about sixty (60) degrees in an off-axis direction.

14. The FRP composite jacket system of claim 1, wherein the FRP composite jacket system is formed using a vacuum-assisted resin transfer molding (VARTM) process.

15. The FRP composite jacket system of claim 1, wherein the thermosetting epoxy resin further comprises epichlorohydrin, polyoxypropylenediamine, or combinations thereof.

16. The composite jacket system of claim 1, wherein the core layer is about 0.55-in thick.

17. A fiber-reinforced polymer (FRP) composite jacket system for a tank car, comprising:
at least a portion of an outer surface of a tank car shell;
a core layer comprising a polymeric material;
an outer jacket comprising a plurality of plies joined together by a plurality of stitch lines;
wherein the plurality of plies comprises a plurality of aramid fabric layers in contact with a plurality of glass fabric layers;
wherein at least one of the plies of the plurality of plies comprises fibers substantially oriented in an on-axis direction;
wherein at least one of the plies of the plurality of plies comprises fibers substantially oriented in an off-axis direction ranging between about thirty (30) and sixty (60) degrees;
wherein at least a portion of the outer surface of the tank car shell is in contact with an inner surface of the core layer;
wherein an outer surface of the core layer is in contact with an inner surface of the outer jacket; and
wherein the core layer and the outer jacket are compressed against at least a portion of the outside surface of the tank car shell and bonded by a thermosetting epoxy resin to form the FRP composite jacket system;
wherein the FRP composite jacket system is formed using a vacuum-assisted resin transfer molding (VARTM) process.

18. The FRP composite jacket system of claim 17, wherein the FRP composite jacket system is an in situ retrofit for an in-service tank car; and
wherein the tank car shell is an outer tank car shell on the in-service tank car.

19. The FRP composite jacket system of claim 17, wherein the FRP composite jacket system is manufactured as a new component of a new tank car; and
wherein the tank car shell is an inner tank car shell of the new tank car.

20. A fiber-reinforced polymer (FRP) composite jacket assembly, comprising:
a core layer comprising a polymeric material;
an outer jacket comprising a plurality of plies joined together by a plurality of stitch lines comprising aramid thread with thickness ranging between about two (2) to eight (8) denier;
wherein the plurality of stitch lines is substantially parallel;
wherein the plurality of plies comprises at least six (6) aramid fabric layers in sequential alternating contact with at least six (6) glass fabric layers;
wherein at least one of the plies of the plurality of plies comprises fibers substantially oriented in an on-axis direction;
wherein at least one of the plies of the plurality of plies comprises fibers substantially oriented in an off-axis direction ranging between about thirty (30) and sixty (60) degrees;
wherein an outer surface of the core layer is in contact with an inner surface of the outer jacket; and
wherein the inner surface of the outer jacket comprises an aramid fabric layer and an outer surface of the outer jacket comprises a glass fabric layer.
